(19) United States
(12) Patent Application Publication
(10) Pub. No.: US 2010/0254322 A1
(43) Pub. Date: Oct. 7, 2010

(54) METHOD FOR ADJUSTING MODULATION AND CODING SCHEME BASED ON SIGNAL QUALITY

(75) Inventors: YEN CHIN LIAO, HSINCHU COUNTY (TW); CHUN HSIEN WEN, HSINCHU COUNTY (TW); CHENG HSUAN WU, HSINCHU COUNTY (TW); JIUNN TSAIR CHEN, HSINCHU COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, HSINCHU COUNTY (TW)

(21) Appl. No.: 12/551,040

(22) Filed: Aug. 31, 2009

(30) Foreign Application Priority Data
Apr. 6, 2009 (TW) 098111333

(51) Int. Cl. H04W 8/00; H04L 27/00; H04L 25/03

(52) U.S. Cl. 370/329; 375/295; 375/296

(57) ABSTRACT

A method for adjusting a modulation and coding scheme based on signal quality comprises the steps of: determining a reference modulation and coding scheme based on signal reception qualities of transmitted signals according to a plurality of modulation and coding schemes; determining a temporary modulation and coding scheme according to a modulation and coding scheme selection method; determining a final modulation and coding scheme according to a first table and the differences between the reference modulation and coding scheme and the temporary modulation and coding scheme.

### BACKGROUND OF THE INVENTION

1. Field of the Invention

The present invention relates to a method for adjusting a modulation and coding scheme of a communication system, and more particularly, to a method for adjusting a modulation and coding scheme based on signal reception quality.

2. Description of the Related Art

In Wi-Fi wireless local area networks, such as those following the IEEE 802.11n standard, a receiver is required to suggest transmitter modulation and coding schemes (MCS) based on transmission environment, and the MCS adopted by the transmitter is selected according to variations in the transmission environment so as to maintain optimal transmission throughput.

Among the many methods for determining an MCS, automatic rate fallback (ARF) algorithm is a widely used technique. The ARF method establishes a priority order for every MCS for the applied communication system, and calculates the packet error rate (PER) for a fixed amount of time in the receiver. If, within a fixed amount of time, the PER in the receiver exceeds an upper threshold, an MCS with a lower data rate is adopted according to the priority order. If, in the fixed amount of time, the PER in the receiver drops below a lower threshold, another MCS with a higher data rate is adopted according to the priority order.

Another popular MCS selection method is based on the transmission environment; that is, selecting the MCS for the transmitter based on the signal-to-noise ratio (SNR). For example, FIG. 1 shows experiment results of the optimum MCSs for different SNRs in an IEEE 802.11n wireless communication system. As shown in FIG. 1, the system structure is a double antenna system, wherein a double transmission antenna and a double receiving antenna are included. There are 16 MCSs available, of which number 0 to number 7 are single spatial stream MCSs, and number 8 to number 15 are double spatial stream MCSs. The receiver stores the experiment results shown in FIG. 1 in a table and selects the MCS adopted by the transmitter according to the stored experiment results.

However, most MCS selection methods (such as the two aforementioned methods) are established based on simulated communication environment or experiment results. If a significant difference exists between the simulated communication environment or the experiment results and the actual communication environment, these MCS selection methods will fail to find the optimum MCS for the environment. In addition, some communication systems can utilize suggested MCSs provided by the receiver. Such receiver may also generate the suggested MCSs based on simulated communication environment or experiment results. Likewise, if a significant difference exists between the simulated communication environment or the experiment results and the actual communication environment, the suggested MCSs may not be the optimum MCS for the environment. Therefore, there is a need to design a method for adjusting an MCS based on signal reception qualities.

### SUMMARY OF THE INVENTION

The method for adjusting an MCS according to one embodiment of the present invention comprises the steps of: determining a reference modulation and coding scheme based on signal reception qualities of transmitted signals according to a plurality of modulation and coding schemes; determining a temporary modulation and coding scheme based on a modulation and coding scheme selection method; and determining a final modulation and coding scheme based on a first table and the difference between the temporary modulation and coding scheme and the reference modulation and coding scheme.

The method for adjusting an MCS according to another embodiment of the present invention comprises the steps of: determining a reference modulation and coding scheme based on signal reception qualities of transmitted signals according to a plurality of modulation and coding schemes; determining a temporary modulation and coding scheme based on a first modulation and coding scheme selection method; determining adjusted signal-to-noise ratios based on the signal-to-noise ratios of the transmitted signals and the difference between the temporary modulation and coding scheme and the reference modulation and coding scheme; and determining a final modulation and coding scheme based on the determined adjusted signal-to-noise ratios and a second modulation and coding scheme selection method.

### BRIEF DESCRIPTION OF THE DRAWINGS

The objectives and advantages of the present invention will become apparent upon reading the following description and upon referring to the accompanying drawings of which:

FIG. 1 shows experiment results of the optimum MCSs for different SNRs;

FIG. 2 shows a method for adjusting an MCS based on signal reception qualities according to an embodiment of the present invention;

FIG. 3 shows a method for adjusting an MCS based on signal reception qualities according to another embodiment of the present invention; and

FIG. 4 shows a method for adjusting an MCS based on signal reception qualities according to yet another embodiment of the present invention.

### DETAILED DESCRIPTION OF THE INVENTION

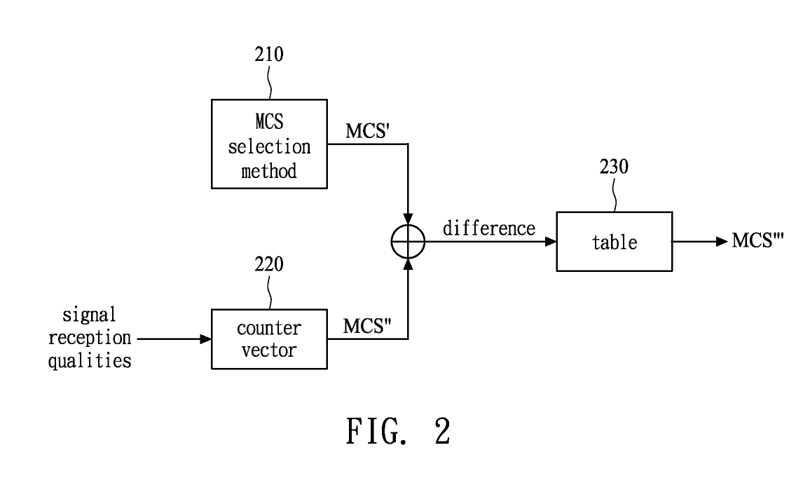

FIG. 2 shows a method for adjusting an MCS based on signal reception qualities according to an embodiment of the present invention. As shown in FIG. 2, a transmitter of a communication system determines a temporary modulation and coding scheme MCS′ based on an MCS selection method 210. The transmitter then determines a reference modulation and coding scheme MCS″ based on a counter vector 220 and signal reception qualities of a plurality of transmitted signals according to various MCSs. The transmitter then determines a modulation and coding scheme MCSs′″ based on a table 230 and the difference between the temporary modulation and coding scheme MCS′ and the reference modulation and coding scheme MCS″.

The following example illustrates a communication system adjusting an MCS according to the method shown in FIG. 2, wherein the communication system exhibits at least two antennas, and is in accordance with the IEEE 802.11n standard. The communication system has 16 MCSs, of which eight are single spatial stream MCSs (MCS0 to MCS7), and eight are double spatial stream MCSs (MCS8 to MCS15). The MCS selection method 210 could be the ARF algorithm, an MCS selection method based on the transmission environment or any other method for adjusting an MCS. The counter vector 220 is for the measurement of the signal reception qualities of the communication system, wherein the length of the counter vector 220 is 16 and the initial value of the counter vector 220 is 0.

When utilizing the MCS selection method 210, the communication system transmits signals with different MCSs, and the counting algorithm of the counter vector 220 is based on the following pseudo code:

If (Ack==1)

mcsScore[m]=mcsScore[m]+1;

Else

mcsScore[m]=mcsScore[m]−1;

wherein ACK is the acknowledge signal of the transmitted signal, mcsScore is the counter vector 220 and m is an integer ranging from 1 to 16.

As shown in the pseudo code, when the communication system transmits a signal with an MCS, such as MCS3, the counter vector 220 records the signal reception quality of the transmitted signal. If the ACK signal of the transmitted signal is 1, the corresponding value of the counter vector 220 is incremented by 1; i.e. the value of mcsScore[3] is incremented by 1. If the ACK signal of the transmitted signal is 0, the corresponding value of the counter vector 220 is decremented by 1, i.e. the value of mcsScore[3] is decremented by 1.

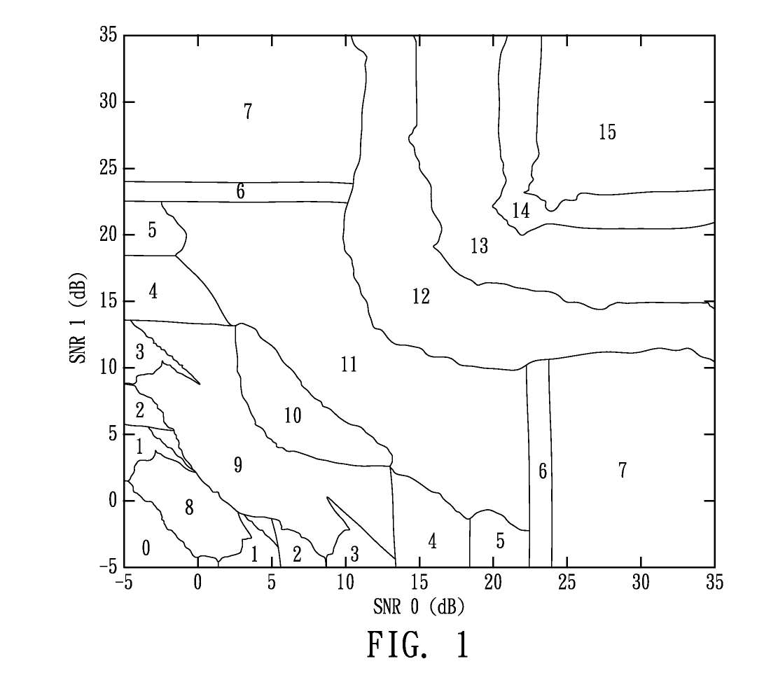

After the execution of the MCS selection method 210 is finished, a temporary modulation and coding scheme MCS′ is obtained. The communication system then selects an MCS corresponding to the greatest value recorded in the counter vector 220 as the reference modulation and coding scheme MCS″. In this example, the temporary modulation and coding scheme MCS′ is MCS10, and the reference modulation and coding scheme MCS″ is MCS3. Next, a table is referenced to obtain the values of Mx and My, which correspond to MCS′ and MCS″ respectively, wherein both Mx and My represent the value of each antenna of the corresponding MCS. The table is established based on the experiment results shown in FIG. 1 and is shown as follows:

| | Mcs | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| Mx | 0 | 1 | 2 | 3 | 4 | 5 | 6 | 7 | 1 | 3 | 3 | 5 | 6 | 6 | 6 | 6 |
| My | 0 | 0 | 0 | 0 | 0 | 0 | 0 | 0 | 1 | 1 | 2 | 1 | 1 | 2 | 3 | 4 |

Following the table, the value of Mx′ corresponding to MCS′ is 3, the value of My′ corresponding to MCS′ is 2, the value of Mx″ corresponding to MCS″ is 3 and the value of My″ corresponding to MCS″ is 0. Next, a modulation and coding scheme MCS′″ is determined based on the table 230 and the difference between MCS′ and MCS″, wherein the difference between MCS′ and MCS″ is calculated as follows:

Δ₁=Mx′−Mx″;

Δ₂=My′−My″;

Following the equations shown above, it can be obtained that Δ₁ is 0 and Δ₂ is 2. The indexes of the table 230 are obtained according to the difference between MCS′ and MCS″, wherein the indexes are calculated as follows:

X=rowIndex=min{7, max[Mx′−floor(Δ₁*c₁),0]+1};

Y columnIndex=min{4, max[My′−floor(Δ₂*c₂),0]+1}; wherein min is the operation of the selection of the minimum value, max is the operation of the selection of the maximum value, floor is the floor operation and c₁ and c₂ are constants greater than 0.

Following the equations shown above, if c₁ and c₂ are both equal to 0.5, it can be obtained that X is 4 and Y is 2. Based on the indexes, the table 230 is referenced to obtain the modulation and coding scheme MCS″, wherein the table 230 is established based on the experiment results shown in FIG. 1 and is shown as follows:

| | | | | |
|---|---|---|---|---|
| 0 | 8 | 8 | 8 | 8 |
| 1 | 8 | 9 | 9 | 9 |
| 2 | 9 | 10 | 11 | 11 |
| 3 | 9 | 10 | 11 | 12 |
| 4 | 11 | 12 | 13 | 13 |
| 5 | 11 | 12 | 13 | 14 |
| 6 | 12 | 13 | 14 | 15 |
| 7 | 12 | 13 | 14 | 15 |

According to table 230, the obtained MCS′″ is MCS9.

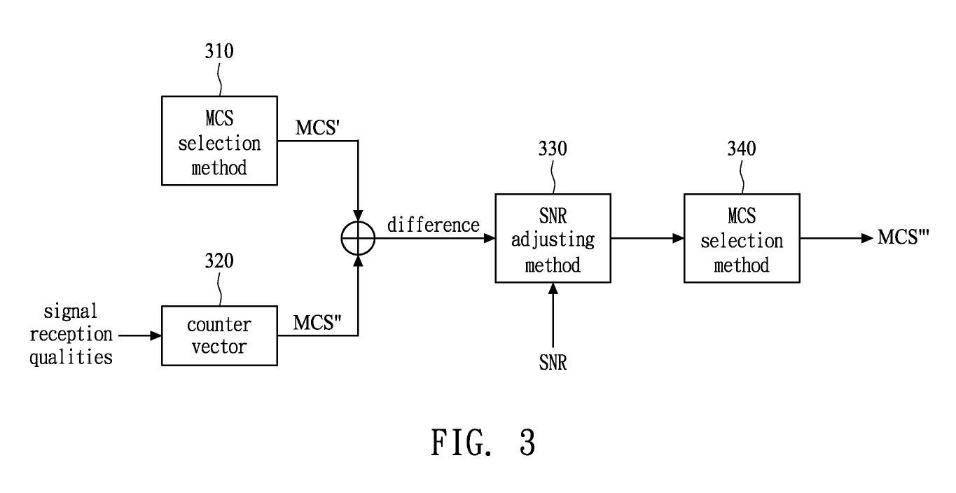

FIG. 3 shows a method for adjusting an MCS based on signal reception qualities according to another embodiment of the present invention. As shown in FIG. 3, a transmitter of a communication system determines a temporary modulation and coding scheme MCS′ based on an MCS selection method 310. The transmitter then determines a reference modulation and coding scheme MCS″ based on a counter vector 320 and signal reception qualities of a plurality of transmitted signals according to various MCSs. Then, the transmitter calculates the difference between the temporary modulation and coding scheme MCS′ and the reference modulation and coding scheme MCS″. A signal-to-noise ratio (SNR) adjusting method 330 is then utilized to obtain an adjusted SNR based on the difference between MCS′ and MCS″ and the SNR of the transmitted signals. An MCS selection method 340 is utilized to determine a modulation and coding scheme MCS′″ based on the adjusted SNR. In some embodiments of the present invention, the MCS selection method 310 is equal to the MCS selection method 340.

The following example illustrates a communication system adjusting an MCS according to the method shown in FIG. 3, wherein the communication system, similar to the communication system in the previous example, exhibits at least two antennas, and is in accordance with the IEEE 802.11n standard. The counting algorithm of the counter vector 320, the criteria to obtain the values of Mx and My corresponding to MCS′ and MCS″ and the calculation of the difference between MCS′ and MCS″ are all the same as those in the previous example. The calculation of the SNR adjusting method 330 is shown as follows:

SNR1′=SNR1+Δ₁*r₁;

SNR2′=SNR2+Δ₂*r₂; wherein SNR1 and SNR2 are the SNRs obtained at each antenna of the receiver, SNR1′ and SNR2′ are the adjusted SNRs and r₁ and r₂ are constants. The MCS selection method 340 is then utilized based on the adjusted signal-to-noise ratios SNR1′ and SNR2′ to determine the modulation and coding scheme MCS′″.

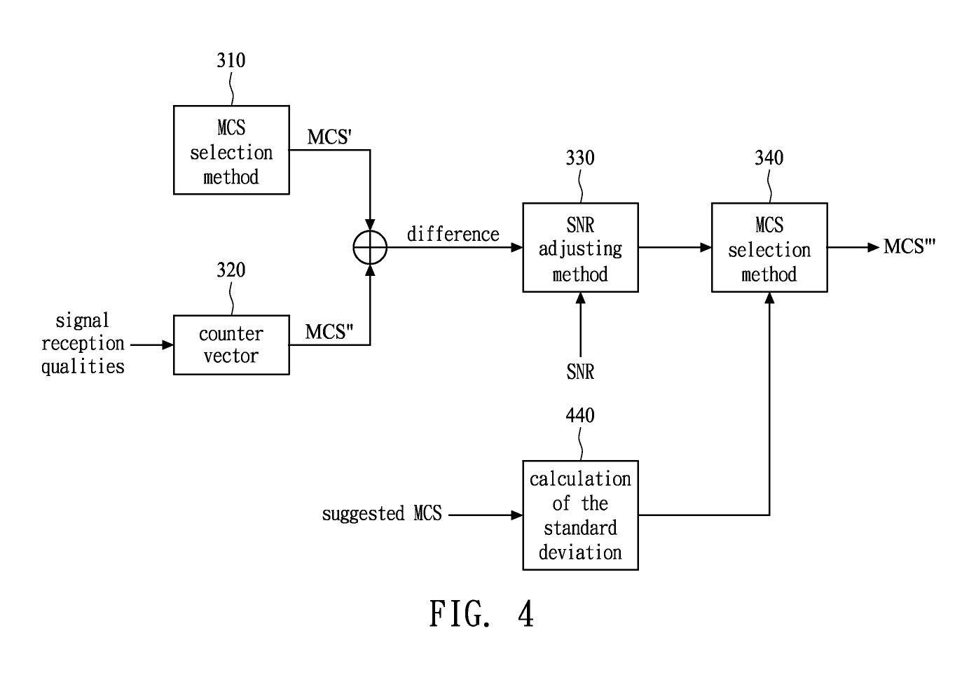

FIG. 4 shows a method for adjusting an MCS based on signal reception qualities according to yet another embodiment of the present invention. Compared with FIG. 3, there is an additional step 440 to calculate the standard deviation in FIG. 4, wherein the standard deviation of the suggested MCSs provided by the receiver at different times is calculated. The weightings of these suggested MCSs are then determined based on the calculated standard deviation such that the modulation and coding scheme MCS′″ is determined. If the calculated standard deviation is too great to be reliable, the weightings of these suggested MCSs can be lowered or even ignored.

In conclusion, the method for adjusting an MCS of the present invention is based on signal reception qualities to adjust the original MCS. Therefore, if a significant difference exists between the simulated communication environment or the experiment results and the actual communication environment, the adjusted MCS will be more suitable to the actual communication environment than the original MCS.

The above-described embodiments of the present invention are intended to be illustrative only. Those skilled in the art may devise numerous alternative embodiments without departing from the scope of the following claims.

What is claimed is:

1. A method for adjusting a modulation and coding scheme, comprising the steps of:
determining a reference modulation and coding scheme based on signal reception qualities of transmitted signals according to a plurality of modulation and coding schemes;
determining a temporary modulation and coding scheme based on a modulation and coding scheme selection method; and
determining a final modulation and coding scheme based on a first table, a difference between the temporary modulation and coding scheme, and the reference modulation and coding scheme.

2. The method of claim 1, wherein the signal reception qualities comprises statistics of acknowledge signals of the transmitted signals.

3. The method of claim 2, wherein the modulation and coding scheme corresponding to the transmitted signals with most acknowledge signals is selected as the reference modulation and coding scheme.

4. The method of claim 1, wherein the step of determining the final modulation and coding scheme comprises the steps of:
determining values of each antenna of a communication system corresponding to the temporary modulation and coding scheme and the reference modulation and coding scheme based on a second table;
calculating the difference between the temporary modulation and coding scheme and the reference modulation and coding scheme based on the determined values; and
determining the final modulation and coding scheme based on the first table and the calculated difference.

5. The method of claim 4, wherein the difference between the temporary modulation and coding scheme and the reference modulation and coding scheme is calculated as Δ=M′−M″, wherein Δ is a difference of a single antenna, M′ is a value of the temporary modulation and coding scheme corresponding to a single antenna, and M″ is a value of the reference modulation and coding scheme corresponding to a single antenna.

6. The method of claim 1, which is utilized in a system having at least two antennas.

7. The method of claim 1, which is utilized in a wireless communication network complying with IEEE 802.11n standard.

8. A method for adjusting a modulation and coding scheme, comprising the steps of:
determining a reference modulation and coding scheme based on signal reception qualities of transmitted signals according to a plurality of modulation and coding schemes;
determining a temporary modulation and coding scheme based on a first modulation and coding scheme selection method;
determining adjusted signal-to-noise ratios based on signal-to-noise ratios of the transmitted signals and a difference between the temporary modulation and coding scheme and the reference modulation and coding scheme; and
determining a final modulation and coding scheme based on the adjusted signal-to-noise ratios and a second modulation and coding scheme selection method.

9. The method of claim 8, wherein the signal reception qualities comprise statistics of acknowledge signals of the transmitted signals.

10. The method of claim 9, wherein the modulation and coding scheme corresponding to the transmitted signals with most acknowledge signals is selected as the reference modulation and coding scheme.

11. The method of claim 8, wherein the step of determining the adjusted signal-to-noise ratios comprises the steps of:
determining values of each antenna of a communication system corresponding to the temporary modulation and coding scheme and the reference modulation and coding scheme based on a table;
calculating the difference between the temporary modulation and coding scheme and the reference modulation and coding scheme based on the determined values; and
determining the adjusted signal-to-noise ratios based on the calculated difference and the signal-to-noise ratios of the transmitted signals.

12. The method of claim 11, wherein the difference between the temporary modulation and coding scheme and the reference modulation and coding scheme is calculated as Δ=M′−M″, wherein Δ is a difference of a single antenna, M′ is a value of the temporary modulation and coding scheme corresponding to a single antenna, and M″ is a value of the reference modulation and coding scheme corresponding to a single antenna.

13. The method of claim 8, further comprising the step of:
adjusting the final modulation and coding scheme based on suggested modulation and coding schemes provided by a receiving end.

14. The method of claim 13, wherein the adjustment of the final modulation and coding scheme is based on weightings of the suggested modulation and coding schemes, and the weightings of the suggested modulation and coding schemes are determined by a reliability of the suggested modulation and coding schemes.

15. The method of claim 14, wherein the reliability of the suggested modulation and coding schemes is based on a standard deviation of the suggested modulation and coding schemes.

16. The method of claim 8, wherein the first modulation and coding scheme selection method and the second modulation and coding scheme selection method are the same.

17. The method of claim 8, which is utilized in a system having at least two antennas.

18. The method of claim 8, which is utilized in a wireless communication network complying with IEEE 802.11n standard.
